(19) United States
(12) Patent Application Publication
(10) Pub. No.: US 2024/0215742 A1
(43) Pub. Date: Jul. 4, 2024

(54) HIGH-STRENGTH ENVIRONMENTALLY-FRIENDLY TABLEWARE

(71) Applicant: SABERT(ZHONGSHAN)LIMITED, Zhongshan City (CN)

(72) Inventor: Kam Yiu WONG, Zhongshan City (CN)

(73) Assignee: SABERT(ZHONGSHAN)LIMITED, Zhongshan City (CN)

(21) Appl. No.: 18/430,410

(22) Filed: Feb. 1, 2024

Related U.S. Application Data
(63) Continuation of application No. PCT/CN2021/104129, filed on Jul. 2, 2021.

(30) Foreign Application Priority Data
Nov. 30, 2020 (CN) CN202011371023.5

(51) Int. Cl. A47G 21/02; A47G 21/04

(52) U.S. Cl. CPC A47G 21/023; A47G 21/04

(57) ABSTRACT

High-strength environment-friendly tableware is provided, and relates to the field of tableware. The high-strength environment-friendly tableware includes a handle and a main body, and the main body is located at one end of the handle. The handle has a recess, the recess forms a hollow portion, and the hollow portion extends in a length direction of the handle. A reinforcing member is mounted in the hollow portion, and a first end of the reinforcing member abuts against a joint between the main body and the handle.

### PRIORITY CLAIM

This is a continuation application of PCT application No. PCT/CN2021/104129 filed on Jul. 2, 2021. Priority is claimed on Chinese application No. CN202011371023.5, filed Nov. 30, 2020, the content of which is incorporated herein by reference.

### TECHNICAL FIELD

This application relates to the field of tableware, and in particular, to high-strength environment-friendly tableware made of environment-friendly materials such as pulp.

### BACKGROUND

Disposable tableware is common tableware. Currently, the disposable tableware is mainly plastic tableware, such as a plate, a table knife, a fork, a spoon, and a spork made of plastic. The plastic tableware is usually made of materials capable of being directly in contact with food. With the increasing environmental awareness, people realize that most of the plastic tableware in the market is not biodegradable, such as PP, PET, and PE. Therefore, researches for replacing the plastic tableware with degradable tableware have been considered. Among them, tableware made of polylactic acid (PLA) materials is industrially degradable tableware that can replace the plastic tableware. However, polylactic acid tableware is expensive due to high costs of the polylactic acid materials, and consequently cannot be widely used.

Therefore, it is considered to use materials which are more environment-friendly and have low production costs to manufacture disposable environment-friendly tableware. Among them, pulp molded tableware is environment-friendly tableware relatively popular in the market in recent years, and such tableware has advantages and characteristics of replacing some plastic tableware. During production of the existing pulp molded tableware, raw materials such as paper and plant residues need to be crushed to form pulp aqueous solution with specific concentration. The water is sucked away from the pulp aqueous solution through a vacuum system to form a wet blank, and the wet blank is then dried through high-temperature hot pressing to form a dry product.

However, pulp molded tableware is mainly made of raw materials such as paper, which has low rigidity, and is prone to deformation during use. For tableware such as a table knife, a fork, and a spoon, handles thereof are prone to deformation after being held for a while by a user. In addition, the teeth of the fork are prone to fracture, and there are also problems such as bending and deformation between the handle and an operating portion (referred to as a “main body” below) of the table knife, the fork, or the spoon. Once tableware such as a table knife, a fork, and a spoon are bent and deformed, the tableware can no longer be used, which limits the popularization and the application of the pulp molded tableware.

For this reason, some existing pulp molded tableware is provided with flaps on a periphery of the main body to improve strength of the main body, but a problem of deformation of the handle caused by force is not considered. For example, a cross section of the handle includes a bottom wall and two side walls. When a user holds the handle, fingers of the user often press against the two side walls of the handle, causing the two side walls to deform towards the middle. Due to poor resilience of the pulp molded tableware, when the user holds the handle for a long time, the handle is prone to deformation. Especially when the user needs to hold the table knife with force to cut off food, the handle is more prone to deformation due to excessively large holding force, affecting use of the pulp molded tableware.

In addition, some existing pulp molded tableware is provided with a reinforcing rib on the main body or the handle, but the reinforcing rib is recessed towards one direction, that is, the reinforcing rib is recessed towards one direction from one plane. In this way, a slope of an edge of the reinforcing rib changes abruptly, and during molding, the edge of the reinforcing rib is prone to cracking, increasing a defective rate of the pulp molded tableware.

### Technical Problems

A first objective of this application is to provide high-strength environment-friendly tableware that effectively avoids bending and deformation between a handle and a main body.

A second objective of this application is to provide high-strength environment-friendly tableware that effectively prevents a handle from being deformed under force.

### Technical Solutions

To achieve the above first objective, the high-strength environment-friendly tableware provided in this application includes a handle and a main body, and the main body is located at one end of the handle. The handle has a recess, the recess forms a hollow portion, the hollow portion extends in a length direction of the handle, a reinforcing member is mounted in the hollow portion, and a first end of the reinforcing member abuts against a joint between the main body and the handle.

In a further solution, on a cross section in an extending direction of the handle, the handle has a bottom wall and side walls located at two ends of the bottom wall; and at least one of the two side walls is provided with a limiting member, the limiting member extends on the side wall towards the middle of the handle, and an edge portion of the reinforcing member abuts against a side that is of the limiting member and that is close to the bottom wall of the handle.

In a further solution, both side walls of the handle are provided with at least one limiting member. In this way, the reinforcing member is limited and fastened on both side walls of the handle, so that a limiting effect on the reinforcing member is better.

In a still further solution, on the same side wall of the handle, the plurality of limiting members are arranged sequentially in the extending direction of the handle.

In a still further solution, the edge portion is disposed on both sides of the reinforcing member, and the edge portions on the two sides abut against inner surfaces of the side walls of the handle.

In a still further solution, a second end of the reinforcing member abuts against an inner surface at an end of the handle.

In a still further solution, the reinforcing member is connected to the handle by using a connecting member. Preferably, the connecting member is a flexible connecting member capable of being bent. In addition, the reinforcing member and the connecting member are molded together, and a thickness of the connecting member is equal to a thickness of the reinforcing member.

In a still further solution, a first end of the connecting member is connected to the edge portion of the reinforcing member, and a second end of the connecting member is connected to the side wall of the handle.

In a still further solution, a first end of the connecting member is connected to a second end of the reinforcing member, a second end of the connecting member is connected to an end of the handle, and the second end of the reinforcing member is disposed opposite to the first end of the reinforcing member.

In a still further solution, on a cross section in an extending direction of the reinforcing member, there is an arch portion in the middle of the reinforcing member, and the arch portion is bent in a direction away from the bottom wall of the handle.

To achieve the above second objective, the high-strength environment-friendly tableware provided in this application includes a handle and a main body, and the main body is located at one end of the handle. In addition, the handle has a recess, the recess forms a hollow portion, and the hollow portion extends in a length direction of the handle. On a cross section in an extending direction of the handle, the handle has a bottom wall and side walls located at two ends of the bottom wall, a first edge flap is disposed at a free end of the side wall, a thickness of the first edge flap is equal to a thickness of the side wall, and corners of the first edge flap are arc chamfers.

In a further solution, the first edge flaps corresponding to the two side walls are on the same plane.

In a further solution, the side wall is disposed obliquely with the first edge flap, and an angle between the side wall and the first edge flap is an obtuse angle.

In a further solution, a periphery of the main body is provided with a second edge flap, and a thickness of the second edge flap is equal to a thickness of the main body.

In a still further solution, the environment-friendly tableware is a fork, the main body is provided with at least two teeth, and a periphery of each tooth is provided with the second edge flap.

In a still further solution, a concave reinforcing portion is disposed in the middle of at least one of the teeth.

In a still further solution, the environment-friendly tableware is provided with a reinforcing rib, the reinforcing rib extends from the handle to the main body, and on a cross section in an extending direction of the reinforcing rib, the reinforcing rib includes a concave portion and convex portions located at two ends of the concave portion.

In a still further solution, the concave portion has a first surface and a second surface that are adjacent to each other, and an angle between the first surface and the second surface ranges from 110° to 140°.

In a still further solution, a curvature radius of an outer surface of the concave portion ranges from 2.0 mm to 2.5 mm; and/or a curvature radius of an outer surface of the convex portion ranges from 2.5 mm to 3.0 mm; and/or a curvature radius of an inner surface of the convex portion ranges from 1.5 mm to 2.0 mm.

In a still further solution, a thickness of the concave portion is less than a thickness of the reinforcing rib on the cross section in the extending direction of the reinforcing rib.

### Beneficial Effects

According to the high-strength environment-friendly tableware in this application, the reinforcing member is disposed in the hollow portion of the handle to improve strength of the handle, and the first end of the reinforcing member abuts against the joint between the main body and the handle. The joint between the main body and the handle is most likely to bend, and therefore force provided by the first end of the reinforcing member can support the joint between the main body and the handle, to effectively avoid a problem that the joint between the main body and the handle is bent and deformed under force.

In addition, the reinforcing member is limited by the limiting member disposed on the side wall to fasten the reinforcing member in the hollow portion of the handle, to avoid a problem that the reinforcing member falls off from the handle during use, thereby facilitating use of the environment-friendly tableware. Moreover, during use of the tableware, the reinforcing member continuously provides force for the joint between the handle and the main body to improve strength of the environment-friendly tableware.

In addition, the reinforcing member is limited and fastened on both side walls of the handle, so that a limiting effect on the reinforcing member is better. A plurality of limiting members arranged in the extending direction of the handle are disposed on each side wall of the handle to limit the reinforcing member at a plurality of locations, so that a limiting effect is more desirable, thereby effectively preventing the reinforcing member from falling off.

Furthermore, in addition to abutting against the joint between the handle and the main body through the first end to improve strength of the joint between the handle and the main body, the reinforcing member further abuts against the two side walls of the handle through the edge portions on the two sides, so that strength of the two side walls of the handle can be improved. When a user holds the handle and applies force to the side walls of the handle, a support effect provided by the reinforcing member prevents the two side walls of the handle from being bent and deformed towards the middle, thereby improving strength of the handle.

In addition, the end of the handle has a limiting effect on the second end of the reinforcing member, to avoid a problem that the first end of the reinforcing member no longer abuts against the joint between the handle and the main body because the reinforcing member slides towards a direction of the end of the handle during use of the environment-friendly tableware, thereby ensuring that the first end of the reinforcing member always abuts against the joint between the handle and the main body during use of the environment-friendly tableware.

According to this application, the reinforcing member may be further connected to the handle by using the connecting member. Before use of the environment-friendly tableware, the reinforcing member can be conveniently folded and mounted in the hollow portion of the handle, to avoid a problem that the reinforcing member is easily lost during transportation and storage.

Further, the reinforcing member is connected to the handle through side connection, to avoid a problem that the environment-friendly tableware is excessively long after being expanded, thereby facilitating transportation and storage of the environment-friendly tableware. Moreover, the reinforcing member is further connected to the end of the handle by using the connecting member to facilitate production of the environment-friendly tableware.

In addition, the arch portion is disposed on the reinforcing member, so that strength of the reinforcing member can be improved to avoid bending of the reinforcing member along an axis of the reinforcing member, thereby improving strength of the handle.

In addition, the first edge flaps are disposed at the free ends of the two side walls of the handle, and when a user holds the handle, fingers press against the two first edge flaps, so that force is applied to the side walls through the two edge flaps, and the applied force is loaded on the side walls in a direction perpendicular to the side walls, to avoid loading oblique upward force on the side walls, thereby changing a direction of the loaded force and reducing a situation that stress distribution on the side walls is uneven. When the force applied to the two first edge flaps disappears, the two side walls can rebound, preventing the handle from being damaged and unable to continue to be used.

In addition, because the thicknesses of the first edge flaps are equal to the thicknesses of the side walls, in one aspect, an anti-squeeze capability of the handle is improved through thicker first edge flaps, and in another aspect, during molding of the environment-friendly tableware, it is only necessary to keep a distance between an upper mold and a lower mold fixed. The molding process is simple, which is conducive to production of the environment-friendly tableware.

The corners of the first edge flaps are arranged to be arc chamfers, that is, no edges are disposed at the corners of the first edge flaps, so that a phenomenon that a user touches the edges of the first edge flaps to cause discomfort when holding the handle can be avoided, and the user can better apply force in opposite directions to avoid damage to the handle.

In addition, when a user holds the handle, the applied force is actually loaded oppositely from the same plane, the force applied on the two side walls is more even, and the handle is less prone to damage. Moreover, because the side walls and the first edge flaps are not perpendicular to each other, an open end of the cross section of the handle is relatively large. After the two side walls are slightly deformed by being squeezed under force, only the open end slightly moves inwards, which does not lead to a fundamental change in a shape of the handle, and can improve strength of the handle.

In addition, the second edge flap on the main body can improve strength of the main body, and prevent the main body from being deformed during use which would otherwise cause the environment-friendly tableware to be unusable.

In addition, the second edge flap is disposed on the periphery of each tooth, and strength of each tooth is improved through the second edge flap, so as to avoid tooth fracture during use of the fork. Moreover, strength of the tooth is further improved through the reinforcing portion, and tooth fracture can be effectively avoided.

In addition, strength of the handle and the main body can be improved through the reinforcing rib, and particularly strength of the joint between the handle and the main body is improved. The reinforcing rib includes the concave portion and the convex portions, that is, the cross section of the reinforcing rib is in a wave shape instead of being recessed in a single direction, and therefore a slope of the edge of the reinforcing rib does not change abruptly. During molding, the edge of the reinforcing rib is not prone to cracking, thereby greatly improving a yield of pulp molded tableware.

A proper angle between the two surfaces of the concave portion is set, so that force applied to the reinforcing rib can be dispersed, thereby effectively improving bending strength of the environment-friendly tableware. In addition, the curvature radiuses of the outer surface of the concave portion, the outer surface of the convex portion, and the inner surface of the convex portion are set, so as to avoid cracking occurred during molding due to excessively small curvature radiuses of the concave portion and the convex portion, thereby improving the yield of the environment-friendly tableware.

Finally, the thickness of the concave portion is relatively small, which is conducive to packaging and transportation of the environment-friendly tableware, and avoids that packaging and use of the environment-friendly tableware are affected due to an excessively large thickness of the concave portion of the reinforcing rib.

### BRIEF DESCRIPTION OF DRAWINGS

FIG. 1 is a structural view of a first embodiment of this application;

FIG. 2 is a front view of the first embodiment of this application;

FIG. 3 is a sectional view taken along line A-A in FIG. 2;

FIG. 4 is an enlarged sectional view taken along line B-B in FIG. 2;

FIG. 5 is an enlarged sectional view taken along line C-C in FIG. 2;

FIG. 6 is an enlarged cross-sectional view taken along line C-C in FIG. 2;

FIG. 7 is an enlarged view of area D in FIG. 3;

FIG. 8 is a structural view of a second embodiment of this application;

FIG. 9 is a front view of the second embodiment of this application;

FIG. 10 is a sectional view taken along line E-E in FIG. 9;

FIG. 11 is an enlarged sectional view taken along line F-F in FIG. 9;

FIG. 12 is an enlarged view of area G in FIG. 10;

FIG. 13 is an enlarged view of area H in FIG. 10;

FIG. 14 is a structural view of a third embodiment of this application;

FIG. 15 is a front view of the third embodiment of this application;

FIG. 16 is a sectional view taken along line I-I in FIG. 15;

FIG. 17 is an enlarged sectional view taken along line J-J in FIG. 15;

FIG. 18 is an enlarged view of area K in FIG. 16;

FIG. 19 is a structural view of a fourth embodiment of this application;

FIG. 20 is a front view of the fourth embodiment of this application;

FIG. 21 is an enlarged sectional view taken along line L-L in FIG. 20;

FIG. 22 is an enlarged sectional view taken along line M-M in FIG. 20;

FIG. 23 is a sectional view taken along line N-N in FIG. 20;

FIG. 24 is an enlarged view of area P in FIG. 23;

FIG. 25 is a sectional view of a spoon handle used as a comparative example;

FIG. 26 is a structural view of a fifth embodiment of this application;

FIG. 27 is a structural exploded view of the fifth embodiment of this application;

FIG. 28 is an enlarged view of area Q in FIG. 27;

FIG. 29 is a sectional view of the fifth embodiment of this application;

FIG. 30 is a structural view of a sixth embodiment of this application;

FIG. 31 is an expanded structural view of the sixth embodiment of this application;

FIG. 32 is a structural view of a seventh embodiment of this application; and

FIG. 33 is an expanded structural view of the seventh embodiment of this application.

This application is further described below with reference to the accompanying drawings and embodiments.

### DESCRIPTION OF EMBODIMENTS

The high-strength environment-friendly tableware in this application is disposable tableware, and is formed by molding and hot-pressing environment-friendly and naturally degradable materials such as pulp and plant fiber. This tableware is environment-friendly and can be degraded in a natural environment, and the environment is not easily polluted even if the tableware is thrown away after being used.

The high-strength environment-friendly tableware in this application mainly includes tableware such as a table knife, a spoon, a fork, and a spork, which are provided with handles and main bodies. Therefore, this application mainly aims at improving the handles and the main bodies to improve bending strength of the environment-friendly tableware.

### First Embodiment

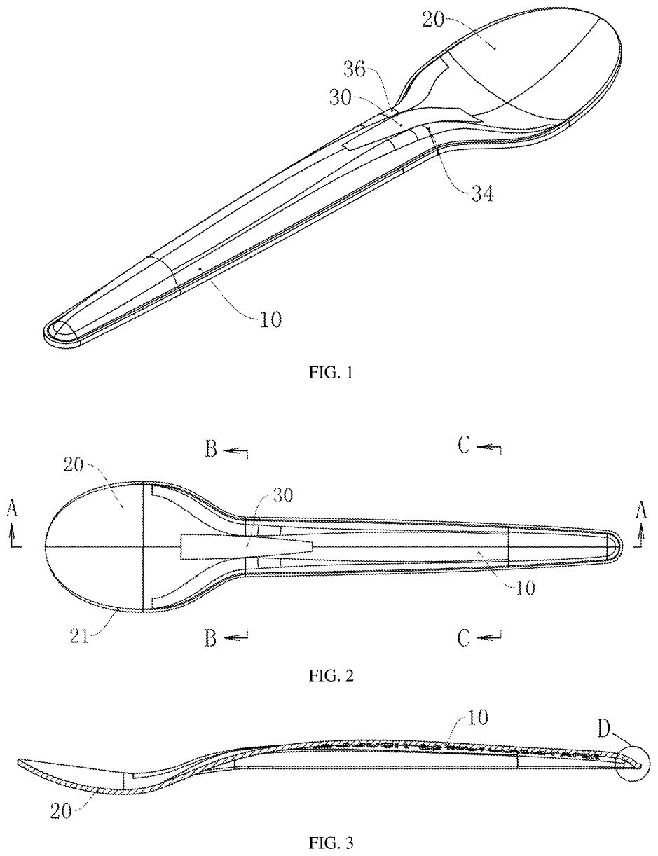

Referring to FIG. 1 to FIG. 3, the high-strength environment-friendly tableware in this embodiment is a pulp molded spoon, and the spoon has a handle 10 in a shape of an elongated strip and a main body 20. The main body 20 is disposed at one end of the handle 10. When the spoon is in use, a user usually holds the handle 10 with fingers. The main body 20 is used for containing food. When the spoon is used for containing food, the main body 20 usually touches hard objects such as plates, so that a joint between the main body 20 and the handle 10 is most likely to bend. Once the main body 20 is bent relative to the handle 10, the spoon is no longer able to be used. To enhance rigidity of the joint between the main body 20 and the handle 10, a reinforcing rib 30 is disposed between the handle 10 and the main body 20 in this embodiment.

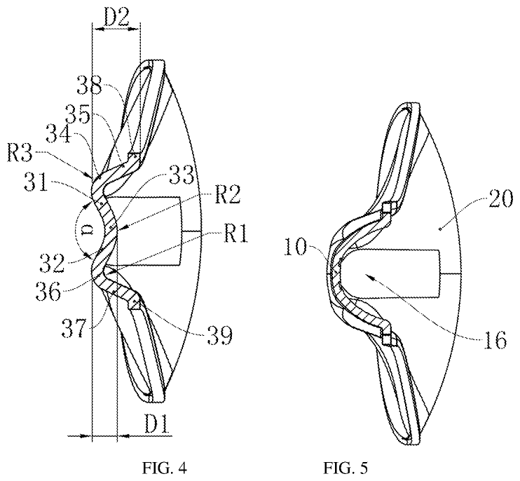

It can be seen from FIG. 1 and FIG. 2 that, the reinforcing rib 30 is substantially in a shape of an elongated strip, and extends from the handle 10 to the main body 20. Referring to FIG. 4, the reinforcing rib 30 is recessed from an upper surface to a lower surface of the spoon, and on a cross section in an extending direction of the reinforcing rib 30, the reinforcing rib 30 includes a concave portion 33 and convex portions 34 and 36 located at two ends of the concave portion 33.

A bottom wall of the concave portion 33 is not flat. In this embodiment, the concave portion 33 has a first surface 31 and a second surface 32, and an angle α formed between the first surface 31 and the second surface 32 is an obtuse angle. Preferably, the angle α ranges from 110° to 140°, and more preferably, the angle α ranges from 120° to 130°. In addition, a side wall 35 is connected to one end of the first surface 31, and the convex portion 34 is formed between the side wall 35 and the first surface 31; and a side wall 37 is connected to one end of the second surface 32, and the convex portion 36 is formed between the side wall 37 and the second surface 32.

It can be seen from FIG. 1 and FIG. 2 that, the cross section of the reinforcing rib 30 is not recessed in one direction, but recessed and protruded in two directions, that is, the concave portion 33 is recessed from the upper surface to the lower surface of the spoon, and the two convex portions 34 and 36 are protruded from the lower surface to the upper surface of the spoon, so that the cross section of the reinforcing rib 30 is in a wave shape, and there is no abrupt change in a slope from a flat plane to an inclined plane at the concave portion 33 and the convex portions 34 and 36, that is, no edges are formed. In this way, cracks are not easily formed at the concave portion 33 and the convex portions 34 and 36 during molding, and a yield of the pulp molded spoon is improved.

Preferably, a curvature radius R2 of an outer surface of the concave portion 33 ranges from 2.0 mm to 2.5 mm, where the outer surface of the concave portion 33 is a surface of the concave portion 33 close to the lower surface of the spoon; curvature radiuses R3 of outer surfaces of the convex portions 34 and 36 range from 2.5 mm to 3.0 mm, where the outer surfaces of the convex portions 34 and 36 are surfaces of the convex portions 34 and 36 close to the upper surface of the spoon; and curvature radiuses R1 of inner surfaces of the convex portions 34 and 36 range from 1.5 mm to 2.0 mm, where the inner surfaces of the convex portions 34 and 36 are surfaces of the convex portions 34 and 36 close to the lower surface of the spoon.

Proper curvature radius of the outer surface of the concave portion 33 and proper curvature radiuses of the inner surface and the outer surface of the convex portion 34 are set, so as to avoid occurrence of cracks on the surfaces of the concave portion 33 or the convex portions 34 and 36 during molding due to the curvature radius being designed to be excessively small.

An edge flap 38 is connected to a free end of the side wall 35, and an edge flap 39 is connected to a free end of the side wall 37. Preferably, the edge flaps 38 and 39 have thicknesses equal to thicknesses of the side walls 35 and 37. Disposing the edge flaps 38 and 39 can improve bending strength of the reinforcing rib 30, so as to prevent the reinforcing rib 30 from being bent and deformed by being squeezed.

Referring to FIG. 4, a thickness of the concave portion 33 is D1, that is, a distance from an end point of the convex portion 34 closest to the upper surface of the spoon to an end point of the concave portion 33 closest to the lower surface of the spoon is D1. A thickness of the reinforcing rib 30 is D2, that is, a distance from the end point of the convex portion 34 closest to the upper surface of the spoon to an end point of the edge flap 38 closest to the lower surface of the spoon is D2. It can be seen from FIG. 4 that the thickness D1 of the concave portion 33 is less than the thickness D2 of the reinforcing rib 30.

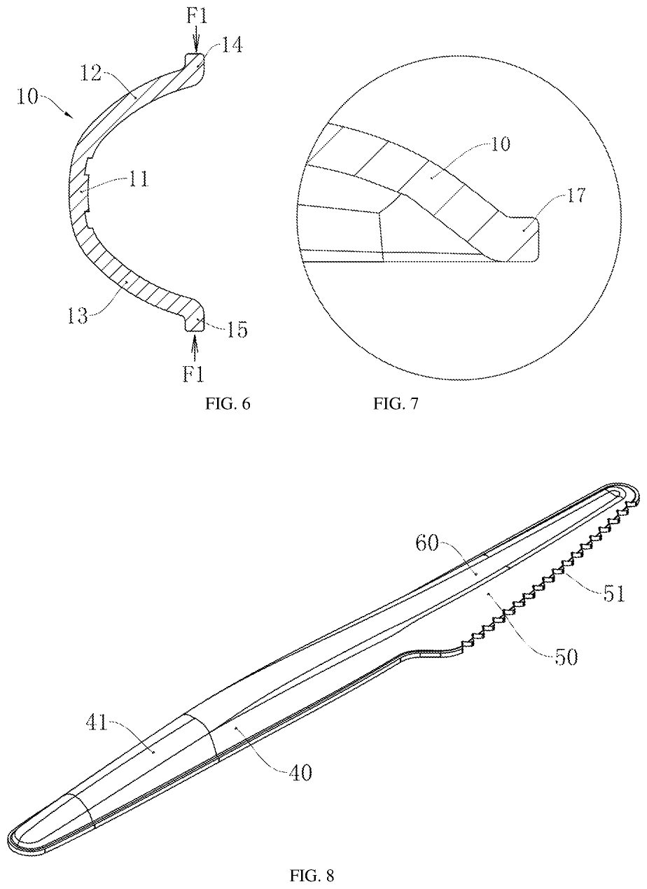

To improve strength of the handle 10, in this embodiment, the handle 10 is designed to be a hollow shape with one side open. Referring to FIG. 5 and FIG. 6, in an extending direction of the handle 10, a cross section of the handle 10 includes a bottom wall 11 and side walls 12 and 13 located at two ends of the bottom wall 11. One end of the side wall 12 is connected to the bottom wall 11, the other end of the side wall 12 is a free end, and a first edge flap 14 is disposed at the free end of the side wall 12. Preferably, the side wall 12 and the bottom wall 11 have a curved transition, that is, no edge is disposed between the side wall 12 and the bottom wall 11. One end of the side wall 13 is connected to the bottom wall 11, and the other end of the side wall 13 is a free end, and a first edge flap 15 is disposed at the free end of the side wall 13. Preferably, the side wall 13 and the bottom wall 11 have a curved transition, that is, no edge is disposed between the side wall 13 and the bottom wall 11. Therefore, the handle 10 forms a recess 16 towards the lower surface of the spoon, and the free ends of the two side walls 12 and 13 can move closer to each other under force.

It can be seen from FIG. 5 and FIG. 6 that, the two opposite side walls 12 and 13 are respectively provided with the first edge flaps 14 and 15. Preferably, the two first edge flaps 14 and 15 are located on the same surface, so that when a user holds the handle 10, applied force F1 separately acts at ends of the first edge flaps 14 and 15, and the applied force F1 is opposite to each other and points to the middle of the handle. In this way, the side walls 12 and 13 move towards the middle and are deformed under the force. When the applied force F1 disappears, the side walls 12 and 13 rebound. Due to low elasticity of materials such as pulp, the side walls 12 and 13 do not rebound much, but as long as force located on the first edge flaps 14 and 15 is not excessively large, the side walls 12 and 13 can still rebound within a specific range, thereby preventing the handle 10 from being severely deformed.

It is assumed that the spoon handle is not provided with the first edge flap. As shown in FIG. 25, the spoon handle is provided with a bottom wall 18 and two side walls 19, and when a user holds the handle, the side walls 19 are directly pressed. Because a position where the user presses the side walls 19 is not fixed, if the user presses free ends of the side walls 19, directions of applied force are not opposite, but inclined, which causes uneven stress on the side walls 19, and easily cause severe deformation of the side walls 19. As a result, the two side walls 19 move inwards, and use of the spoon is affected.

In this embodiment, the side wall 12 and the first edge flap 14 are not disposed vertically, but are inclined to each other. The side wall 12 is substantially arc-shaped, and an angle between the side wall 12 and the first edge flap 14 is an obtuse angle. The side wall 13 and the first edge flap 15 are also inclined to each other, the side wall 13 is substantially arc-shaped, and an angle between the side wall 13 and the first edge flap 15 is also an obtuse angle.

Preferably, thicknesses of the first edge flaps 14 and 15 are equal, and the thicknesses of the first edge flaps 14 and 15 are equal to thicknesses of the side walls 12 and 13. In this way, in one aspect, the thicknesses of the first edge flaps 14 and 15 are designed to be relatively large to improve anti-squeeze capabilities of the first edge flaps 14 and 15, and the first edge flaps 14 and 15 are prevented from being easily deformed by being squeezed due to excessively small thicknesses. In another aspect, a distance between an upper mold and a lower mold can be maintained uniform during molding of the spoon. The spoon in this embodiment is molded by a press molding machine. For this reason, during hot pressing, only the distance between the upper mold and the lower mold needs to be adjusted, which can ensure that the spoon that satisfies a thickness requirement is formed through pressing. The structure of the upper mold and the lower mold is simple, which is conducive to simplifying a molding process of the spoon.

In addition to the first edge flaps 14 and 15 disposed on the two side walls 12 and 13 of the handle 10, a first edge flap is also disposed at an end of the handle 10. Referring to FIG. 7, a free end of the handle 10 is also provided with a first edge flap 17, and a thickness of the first edge flap 17 is equal to a thickness of the handle 10. Furthermore, corners of the first edge flaps 14, 15, and 17 are all arc chamfers, that is, no edges are disposed. When holding the handle 10, the user does not press against the edge and therefore does not feel uncomfortable. It can be seen that the provision of the first edge flap around a periphery of the handle 10 can improve overall bending performance of the handle 10.

A second edge flap 21 is disposed on a periphery of the main body 20 of the spoon. In this embodiment, a thickness of the second edge flap 21 is equal to a thickness of the main body 20, and the second edge flap 21 extends around the circumference of the main body 21. In addition, corners of the second edge flap 21 are also designed as arc chamfers. The purpose of disposing the second edge flap 21 on the periphery of the main body 20 is to improve bending strength of the main body 20 and prevent the main body 20 from being bent and deformed under force.

Preferably, a thickness of the entire spoon is uniform, that is, be it the handle 10, the main body 20, or the reinforcing rib 30, the thickness remains same. Such a design can simplify a production process of the spoon. Specifically, because the spoon is formed by pulp molding and hot pressing, a wet blank needs to be placed on the lower mold when the spoon is pressed by the press molding machine, and the thickness of the formed spoon is controlled by controlling downward movement distance of the upper mold. Therefore, during hot press molding, the distance between the upper mold and the lower mold needs to be controlled, so that the spoon with a uniform thickness can be obtained by pressing. The design of the upper mold and the lower mold is simple, and the control is not complex. Preferably, the thickness of the spoon may range from 0.2 mm to 5.0 mm, and preferably range from 0.5 mm to 1.0 mm.

In addition, the cross section of the reinforcing rib 30 is designed into a wave shape in this embodiment, and the first edge flap is disposed on the periphery of the handle 10, and the second edge flap is arranged on the periphery of the main body 20, both of which can facilitate stacking of spoons. During production, stacking and positioning of a plurality of spoons can be conveniently implemented, so as to facilitate implementation of automated production and also facilitate transportation of spoons. Before the spoon is used, one spoon can be conveniently separated from a plurality of stacked spoons, which is convenient for taking the spoon.

### Second Embodiment

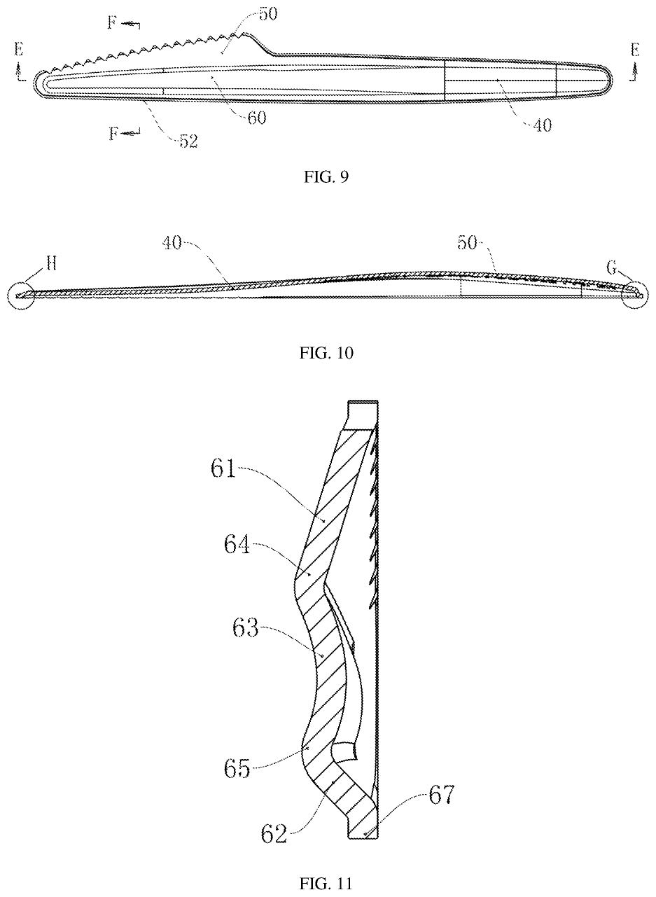

Referring to FIG. 8 to FIG. 10, the high-strength environment-friendly tableware in this embodiment is a table knife made of an environment-friendly material. The table knife includes a handle 40 and a main body 50. The handle 40 is in a shape of an elongated strip, and the main body 50 is located at one end of the handle 40. Because a joint between the main body 50 and the handle 40 is most likely to bend, a reinforcing rib 60 is disposed between the handle 40 and the main body 50 in this embodiment to enhance rigidity of the joint between the main body 50 and the handle 40.

The reinforcing rib 60 is substantially in a shape of an elongated strip, and extends from the handle 40 to the main body 50. Referring to FIG. 11, the reinforcing rib 60 is recessed from an upper surface to a lower surface of the table knife, and on a cross section in an extending direction of the reinforcing rib 60, the reinforcing rib 60 includes a concave portion 63 and convex portions 64 and 65 located at two ends of the concave portion 63.

A bottom wall of the concave portion 63 is not flat. Specifically, the concave portion 63 has two adjacent surfaces, and an angle formed between the two surfaces is an obtuse angle. Preferably, the angle ranges from 110° to 140°, and more preferably, the angle ranges from 120° to 130°. In addition, side walls 61 and 62 are respectively disposed at two ends of a concave portion 63, the convex portion 64 is formed between the side wall 61 and the concave portion 63, and the convex portion 65 is formed between the side wall 62 and the concave portion 63.

It can be seen from FIG. 8 to FIG. 10 that, the cross section of the reinforcing rib 60 is not recessed in one direction, but recessed and protruded in two directions, that is, the concave portion 63 is recessed from the upper surface to the lower surface of the table knife, and the two convex portions 64 and 65 are protruded from the lower surface to the upper surface of the table knife, so that the cross section of the reinforcing rib 60 is in a wave shape, and there is no abrupt change in a slope from a flat plane to an inclined plane at the concave portion 63 and the convex portions 64 and 65, that is, no edges are formed. In this way, cracks are not easily formed at the concave portion 63 and the convex portions 64 and 65 during molding, and a yield of the pulp molded table knife is improved.

In addition, curvature radiuses of inner surfaces and outer surfaces of the concave portion 63 and the convex portions 64 and 65 are properly set, so as to avoid occurrence of cracks on the surfaces of the concave portion 63 or the convex portions 64 and 65 during molding due to excessively small curvature radiuses of the inner surfaces and the outer surfaces of the concave portion 63 and the convex portions 64 and 65. In addition, a thickness of the concave portion 63 is less than a total thickness of the reinforcing rib 60.

An edge flap 67 is connected to a free end of the side wall 62, and a thickness of the edge flap 67 is equal to a thickness of the side wall 62. Disposing the edge flap 67 can improve bending strength of the reinforcing rib 60, so as to prevent the reinforcing rib 60 from being bent and deformed by being squeezed.

To improve strength of the handle 40, in this embodiment, the handle 40 is designed to be a hollow shape with one side open, that is, in an extending direction of the handle 40, a cross section of the handle 40 includes a bottom wall and side walls located at two ends of the bottom wall. One end of the side wall is connected to the bottom wall, the other end of the side wall is a free end, and a first edge flap is disposed at the free end of the side wall. In addition, the first edge flaps on the two side walls are located on the same surface, so that when a user holds the handle 40, applied force separately acts at ends of the first edge flaps, and the two side walls move towards the middle and are deformed under the force. When the applied force disappears, the two side walls rebound. In addition, thicknesses of the two first edge flaps are equal, and the thicknesses of the first edge flaps are also equal to thicknesses of the side walls. A cross-sectional shape of the handle 40 in this embodiment is substantially the same as a cross-sectional shape of the handle in the first embodiment, and is not described herein again.

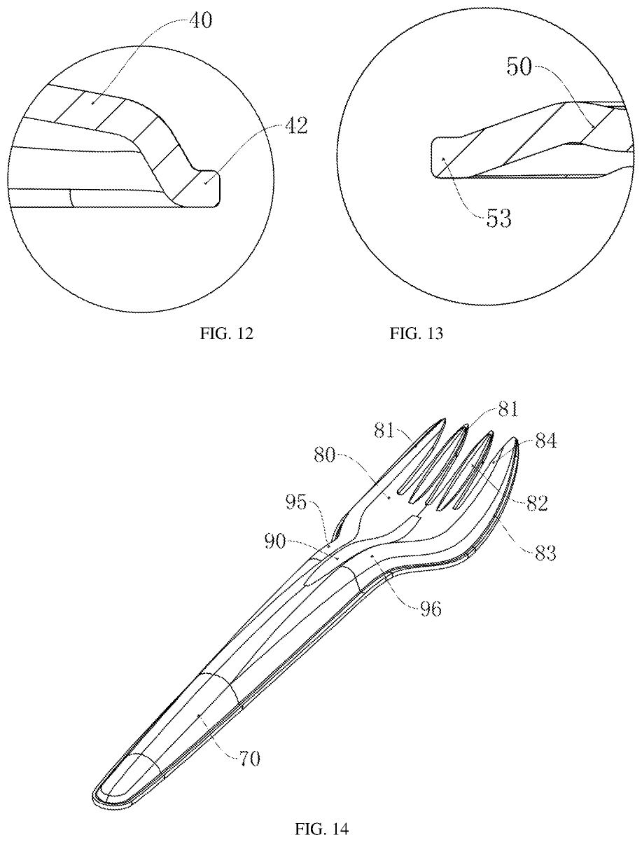

Referring to FIG. 12, a first edge flap 42 is also disposed at a free end of the handle 40, and a thickness of the first edge flap 42 is equal to a thickness of the handle 40. It can be seen that a periphery of the handle 40 is provided with the first edge flap, and corners of the first edge flap are all arc chamfers, that is, no edges are disposed. When holding the handle 40, the user does not press against the edge and therefore does not feel uncomfortable.

In addition, a plurality of teeth 51 are disposed on one side of the main body 50 of the table knife, and a second edge flap 52 is disposed on the other side of the main body 50. Referring to FIG. 13, a second edge flap 53 is disposed at an end of the main body 50. Preferably, thicknesses of the second edge flaps 52 and 53 are equal to a thickness of the main body 50, and corners of the second edge flaps 52 and 53 are also designed as arc chamfers. The purpose of disposing the second edge flaps 52 and 53 on the main body 50 is to improve bending strength of the main body 50 and prevent the main body 50 from being bent and deformed under force.

The cross section of the reinforcing rib 60 is designed into a wave shape in this embodiment, and the first edge flap is disposed on the periphery of the handle 40, and the second edge flap is disposed on the main body 50, both of which can facilitate stacking of table knives. During production, stacking and positioning of a plurality of table knives can be conveniently implemented, so as to facilitate implementation of automated production and also facilitate transportation of table knives. Before the table knife is used, one table knife can be conveniently separated from a plurality of stacked table knives, which is convenient for taking the table knife.

### Third Embodiment

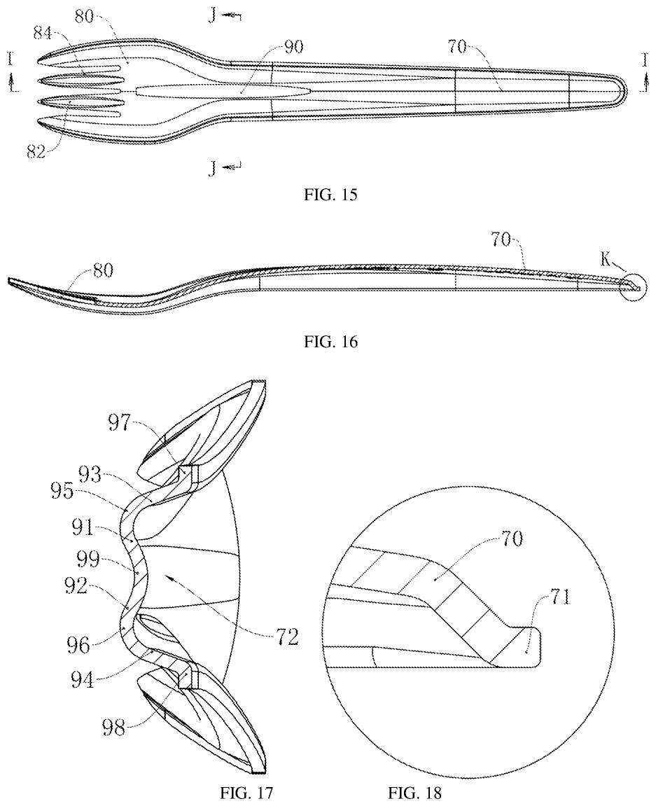

Referring to FIG. 14 to FIG. 16, the high-strength environment-friendly tableware in this embodiment is a fork made of an environment-friendly material. The fork includes a handle 70 and a main body 80. The handle 70 is in a shape of an elongated strip, and the main body 80 is located at one end of the handle 70. Because a joint between the main body 80 and the handle 70 is most likely to bend, a reinforcing rib 90 is disposed between the handle 70 and the main body 80 in this embodiment to enhance rigidity of the joint between the main body 80 and the handle 70.

The reinforcing rib 90 is substantially in a shape of an elongated strip, and extends from the handle 70 to the main body 80. Referring to FIG. 17, the reinforcing rib 90 is recessed from an upper surface to a lower surface direction of the fork, and on a cross section in an extending direction of the reinforcing rib 90, the reinforcing rib 90 includes a concave portion 99 and convex portions 95 and 96 located at two ends of the concave portion 99.

A bottom wall of the concave portion 99 is not flat. Specifically, the concave portion 99 has a first surface 91 and a second surface 92 that are adjacent to each other, and an angle formed between the first surface 91 and the second surface 92 is an obtuse angle. Preferably, the angle ranges from 110° to 140°, and more preferably, the angle ranges from 120° to 130°. In addition, one end of the first surface 91 is connected to a side wall 93, one end of the second surface 92 is connected to a side wall 94, the convex portion 95 is formed between the first surface 91 and the side wall 93, and the convex portion 96 is formed between the second surface 92 and the side wall 94.

It can be seen from FIG. 14 to FIG. 16 that, the cross section of the reinforcing rib 90 is not recessed in one direction, but recessed and protruded in two directions, that is, the concave portion 99 is recessed from the upper surface to the lower surface of the fork, and the two convex portions 95 and 96 are protruded from the lower surface to the upper surface of the fork, so that the cross section of the reinforcing rib 90 is in a wave shape, and there is no abrupt change in a slope from a flat plane to an inclined plane at the concave portion 99 and the convex portions 95 and 96, that is, no edges are formed. In this way, cracks are not easily formed at the concave portion 99 and the convex portions 95 and 96 during molding, and a yield of the pulp molded fork is improved.

In addition, curvature radiuses of inner surfaces and outer surfaces of the concave portion 99 and the convex portions 95 and 96 are properly set, so as to avoid occurrence of cracks on the surfaces of the concave portion 99 or the convex portions 95 and 96 during molding due to excessively small curvature radiuses of the inner surfaces and the outer surfaces of the concave portion 99 and the convex portions 95 and 96. In addition, a thickness of the concave portion 99 is less than a total thickness of the reinforcing rib 90.

An edge flap 97 is connected to a free end of the side wall 93, and a thickness of the edge flap 97 is equal to a thickness of the side wall 92. An edge flap 98 is connected to a free end of the side wall 94, and a thickness of the edge flap 98 is equal to a thickness of the side wall 94. Disposing the edge flaps 97 and 98 can improve bending strength of the reinforcing rib 90, so as to prevent the reinforcing rib 90 from being bent and deformed by being squeezed.

To improve strength of the handle 70, in this embodiment, the handle 70 is designed to be a hollow shape with one side open, that is, in an extending direction of the handle 70, a cross section of the handle 70 includes a bottom wall and side walls located at two ends of the bottom wall. One end of the side wall is connected to the bottom wall, the other end of the side wall is a free end, and a first edge flap is disposed at the free end of the side wall. In addition, the first edge flaps on the two side walls are located on the same surface, so that when a user holds the handle 70, applied force separately acts at ends of the first edge flaps, and the two side walls move towards the middle and are deformed under the force. When the applied force disappears, the two side walls rebound. In addition, thicknesses of the two first edge flaps are equal, and the thicknesses of the first edge flaps are also equal to thicknesses of the side walls. A cross-sectional shape of the handle 70 in this embodiment is substantially the same as a cross-sectional shape of the handle in the first embodiment, and is not described herein again.

Referring to FIG. 18, a first edge flap 71 is also disposed at a free end of the handle 70, and a thickness of the first edge flap 71 is equal to a thickness of the handle 70. It can be seen that a periphery of the handle 70 is provided with the first edge flap, and corners of the first edge flap are all arc chamfers, that is, no edges are disposed. When holding the handle 70, the user does not press against the edge and therefore does not feel uncomfortable.

In addition, a second edge flap 83 is disposed on a periphery of the main body 80 of the fork, four teeth 81 are disposed on the main body 80 of the fork, and a second edge flap 84 is disposed on a periphery of each tooth 81. In addition, thicknesses of the second edge flaps 83 and 84 are equal to a thickness of the main body 80, and corners of the second edge flaps 83 and 84 are also designed as arc chamfers. It can be seen that the second edge flap is disposed on the periphery of the main body 80. The purpose of disposing the second edge flaps 83 and 84 on the main body 80 is to improve bending strength of the main body 80 and prevent the main body 80 from being bent and deformed under force.

In addition, concave reinforcing portions 82 are disposed in the middle of the two middle teeth 81, and the reinforcing portions 82 are recessed from the upper surface to the lower surface of the fork. The reinforcing portions 82 can improve bending performance of the teeth 81 and prevent the teeth 81 from being fractured during use of the fork.

The cross section of the reinforcing rib 90 is designed into a wave shape in this embodiment, and the first edge flap is disposed on the periphery of the handle 70, and the second edge flap is disposed on the periphery of the main body 80, both of which can facilitate stacking of forks. During production, stacking and positioning of a plurality of forks can be conveniently implemented, so as to facilitate implementation of automated production and also facilitate transportation of forks. Before the fork is used, one fork can be conveniently separated from a plurality of forks, which is convenient for taking the fork.

### Fourth Embodiment

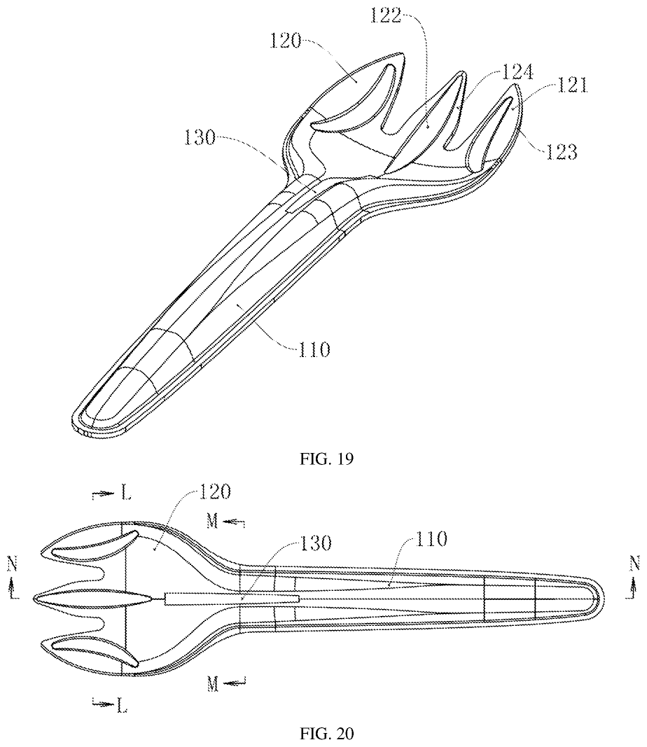

Referring to FIG. 19 and FIG. 20, the high-strength environment-friendly tableware in this embodiment is a spork made of an environment-friendly material, that is, a plurality of teeth are disposed on a spoon, and the spork has functions of both a fork and a spoon. The spork includes a handle 110 and a main body 120. The handle 110 is in a shape of an elongated strip, and the main body 120 is located at one end of the handle 110. Because a joint between the main body 120 and the handle 110 is most likely to bend, a reinforcing rib 130 is disposed between the handle 110 and the main body 120 in this embodiment to enhance rigidity of the joint between the main body 120 and the handle 110.

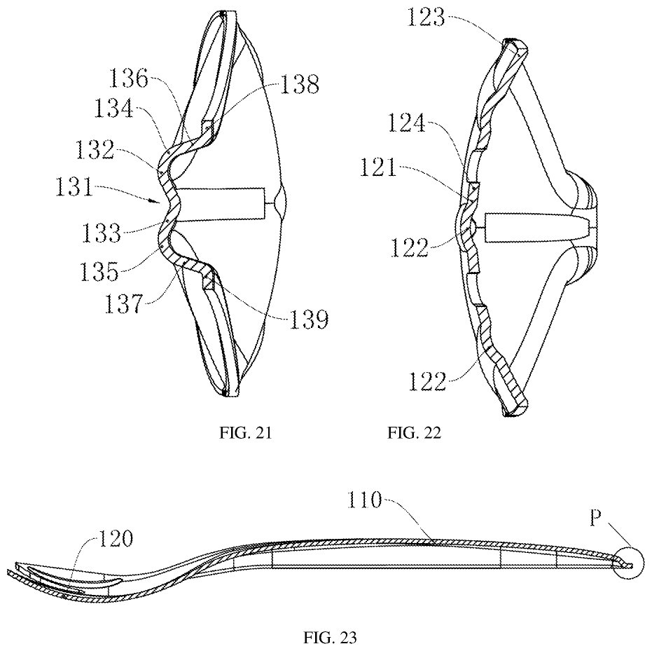

The reinforcing rib 130 is substantially in a shape of an elongated strip, and extends from the handle 110 to the main body 120. Referring to FIG. 21, the reinforcing rib 130 is recessed from an upper surface to a lower surface of the spork, and on a cross section in an extending direction of the reinforcing rib 130, the reinforcing rib 130 includes a concave portion 131 and convex portions 134 and 135 located at two ends of the concave portion 131.

A bottom wall of the concave portion 131 is not flat. Specifically, the concave portion 131 has a first surface 132 and a second surface 133 that are adjacent to each other, and an angle formed between the first surface 132 and the second surface 133 is an obtuse angle. Preferably, the angle ranges from 110° to 140°, and more preferably, the angle ranges from 120° to 130°. In addition, one end of the first surface 132 is connected to a side wall 136, one end of the second surface 133 is connected to a side wall 137, the convex portion 134 is formed between the first surface 132 and the side wall 136, and the convex portion 135 is formed between the second surface 133 and the side wall 137.

It can be seen from FIG. 19 and FIG. 20 that, the cross section of the reinforcing rib 130 is not recessed in one direction, but recessed and protruded in two directions, that is, the concave portion 131 is recessed from the upper surface to the lower surface of the spork, and the two convex portions 132 and 135 are protruded from the lower surface to the upper surface of the spork, so that the cross section of the reinforcing rib 130 is in a wave shape, and there is no abrupt change in a slope from a flat plane to an inclined plane at the concave portion 131 and the convex portions 132 and 135, that is, no edges are formed. In this way, cracks are not easily formed at the concave portion 131 and the convex portions 132 and 135 during molding, and a yield of the pulp molded spork is improved.

In addition, curvature radiuses of inner surfaces and outer surfaces of the concave portion 131 and the convex portions 132 and 135 are properly set, so as to avoid occurrence of cracks on the surfaces of the concave portion 131 or the convex portions 132 and 135 during molding due to excessively small curvature radiuses of the inner surfaces and the outer surfaces of the concave portion 131 and the convex portions 132 and 135. In addition, a thickness of the concave portion 131 is less than a total thickness of the reinforcing rib 130.

An edge flap 138 is connected to a free end of the side wall 136, and a thickness of the edge flap 138 is equal to a thickness of the side wall 136. An edge flap 139 is connected to a free end of the side wall 137, and a thickness of the edge flap 139 is equal to a thickness of the side wall 137. Disposing the edge flaps 138 and 139 can improve bending strength of the reinforcing rib 130, so as to prevent the reinforcing rib 130 from being bent and deformed by being squeezed.

To improve strength of the handle 110, in this embodiment, the handle 110 is designed to be a hollow shape with one side open, that is, in an extending direction of the handle 110, a cross section of the handle 110 includes a bottom wall and side walls located at two ends of the bottom wall. One end of the side wall is connected to the bottom wall, the other end of the side wall is a free end, and a first edge flap is disposed at the free end of the side wall. In addition, the first edge flaps on the two side walls are located on the same surface, so that when a user holds the handle 110, applied force separately acts at ends of the first edge flaps, and the two side walls move towards the middle and are deformed under the force. When the applied force disappears, the two side walls rebound. In addition, thicknesses of the two first edge flaps are equal, and the thicknesses of the first edge flaps are also equal to thicknesses of the side walls. A cross-sectional shape of the handle 110 in this embodiment is substantially the same as a cross-sectional shape of the handle in the first embodiment, and is not described herein again.

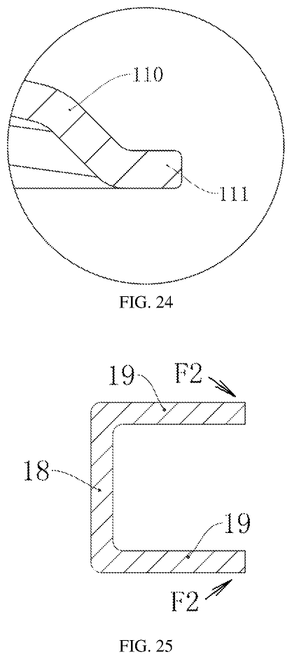

Referring to FIG. 23 and FIG. 24, a first edge flap 111 is also disposed at a free end of the handle 110, and a thickness of the first edge flap 111 is equal to a thickness of the handle 110. It can be seen that a periphery of the handle 110 is provided with the first edge flap, and corners of the first edge flap are all arc chamfers, that is, no edges are disposed. When holding the handle 110, the user does not press against the edge and therefore does not feel uncomfortable.

Referring to FIG. 19 and FIG. 22, a second edge flap 123 is disposed on a periphery of the main body 120 of the spork, three teeth 121 are disposed on the main body 120 of the spork, and a second edge flap 124 is disposed on a periphery of each tooth 121. In addition, thicknesses of the second edge flaps 123 and 124 are equal to a thickness of the main body 120, and corners of the second edge flaps 123 and 124 are also designed as arc chamfers. It can be seen that the second edge flap is disposed on the periphery of the main body 120. The purpose of disposing the second edge flaps 123 and 124 on the main body 120 is to improve bending strength of the main body 120 and prevent the main body 120 from being bent and deformed under force.

In addition, concave reinforcing portions 122 are disposed in the middle of the three teeth 121, and the reinforcing portions 122 are recessed from the upper surface to the lower surface of the spork. The reinforcing portions 122 can improve bending performance of the teeth 121 and prevent the teeth 121 from being fractured during use of the spork.

The cross section of the reinforcing rib 130 is designed into a wave shape in this embodiment, and the first edge flap is disposed on the periphery of the handle 110, and the second edge flap is disposed on the periphery of the main body 120, both of which can facilitate stacking of sporks. During production, stacking and positioning of a plurality of sporks can be conveniently implemented, so as to facilitate implementation of automated production and also facilitate transportation of sporks. Before the spork is used, one spork can be conveniently separated from a plurality of sporks, which is convenient for taking the spork.

In all the plurality of embodiments described above, the reinforcing rib is disposed in the joint between the handle and the main body to improve strength of the joint between the handle and the main body, thereby preventing the joint between the handle and the main body from being bent. To further improve strength of the joint between the handle and the main body, a reinforcing member may be further disposed in this application, for example, the reinforcing member is disposed in the handle, and a first end of the reinforcing member abuts against the joint between the handle and the main body, so as to improve strength of the joint between the handle and the main body. The following uses a spork as an example to describe several manners of disposing the reinforcing member.

### Fifth Embodiment

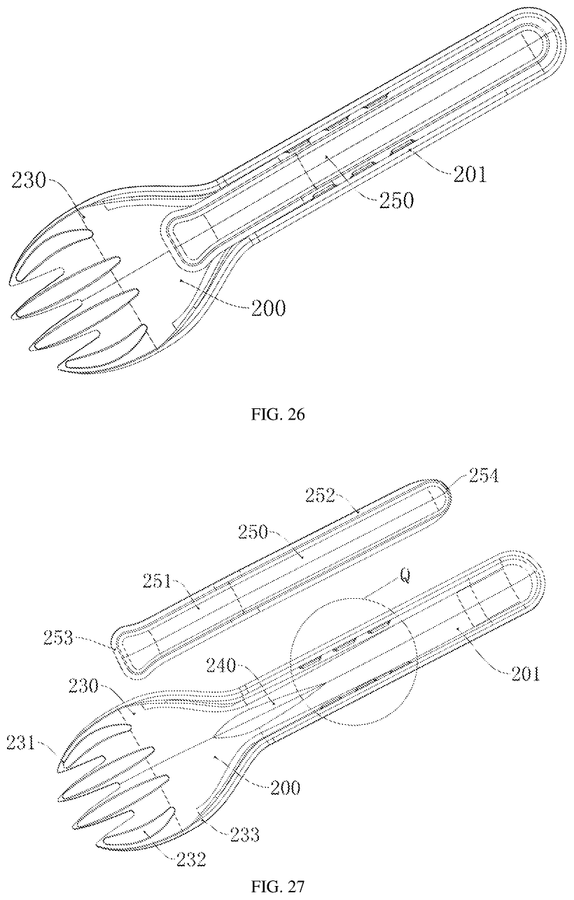

Referring to FIG. 26 and FIG. 27, the high-strength environment-friendly tableware in this embodiment is a spork made of an environment-friendly material, and the spork is provided with four teeth. The spork includes a body 200 and a reinforcing member 250. The reinforcing member 250 may be fixedly mounted in the body 200. In addition, before the reinforcing member 250 is mounted in the body 200, the reinforcing member 250 is separated from the body 200, that is, the reinforcing member 250 is not connected to the body 200 through any connecting member.

A structure of the body 200 of the spork is substantially the same as that of the spork in the fourth embodiment. The body 200 includes a handle 201 and a main body 230. The handle 201 is in a shape of an elongated strip, and the main body 230 is located at one end of the handle 201. A reinforcing rib 240 is disposed between the handle 201 and the main body 230. The reinforcing rib 240 is substantially in a shape of an elongated strip, and extends from the handle 201 to the main body 230. The reinforcing rib 240 is recessed from an upper surface to a lower surface of the body 200, and on a cross section in an extending direction of the reinforcing rib 240, the reinforcing rib 240 includes a concave portion and convex portions located at two ends of the concave portion.

The cross section of the reinforcing rib 240 is not recessed in one direction, but recessed and protruded in two directions, that is, the concave portion is recessed from the upper surface to the lower surface of the spork, and the two convex portions are protruded from the lower surface to the upper surface of the spork, so that the cross section of the reinforcing rib 240 is in a wave shape.

The main body 230 is provided with four teeth 231, and a concave reinforcing portion 232 is disposed in the middle of each tooth 231, and the reinforcing portion 232 is recessed from the upper surface to the lower surface of the spork. The reinforcing portions 232 can improve bending performance of the teeth 231 and prevent the teeth 231 from being fractured during use of the spork.

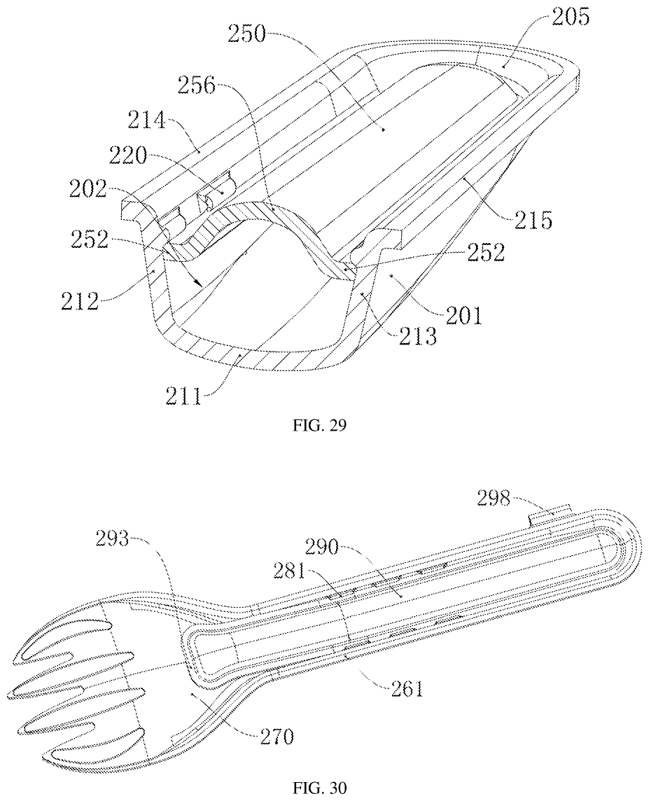

Referring to FIG. 29, the handle 201 forms a recess with one end open on a cross section in an extending direction, and the recess forms a hollow portion 202. The hollow portion 202 extends in a length direction of the handle. The cross section in the extending direction of the handle 201 includes a bottom wall 211 and side walls 212 and 213 located at two ends of the bottom wall 211. An edge flap 214 is connected to a free end of the side wall 212, and a thickness of the edge flap 214 is equal to a thickness of the side wall 212. An edge flap 215 is connected to a free end of the side wall 213, and a thickness of the edge flap 215 is equal to a thickness of the side wall 213.

In addition, the edge flaps 214 and 215 on the two side walls 212 and 213 are located on the same surface, so that when a user holds the handle 201, applied force separately acts at ends of the first edge flaps 214 and 215, and the two side walls 212 and 213 move towards the middle and are deformed under the force. When the applied force disappears, the two side walls 212 and 213 rebound. In addition, thicknesses of the two first edge flaps 214 and 215 are equal, and the thicknesses of the first edge flaps 214 and 215 are also equal to thicknesses of the side walls 212 and 213.

A first edge flap is also disposed at an end 205 of the handle 201, and a thickness of the first edge flap is equal to a thickness of the handle 201. In this way, a periphery of the handle 201 is provided with the first edge flap, and corners of the first edge flap are all arc chamfers, that is, no edges are disposed, to prevent the user from feeling uncomfortable when holding the handle 201.

A second edge flap 233 is disposed on a periphery of the main body 230, and a second edge flap is disposed on a periphery of each tooth 231. In addition, a thickness of the second edge flap 233 is equal to a thickness of the main body 230, and corners of the second edge flap 233 are also designed as arc chamfers. Disposing the second edge flap on the periphery of the main body 230 can improve bending strength of the main body 230 and provide the main body 230 from being bent and deformed under force.

The reinforcing member 250 is detachably mounted in the hollow portion 202 of the handle 201, and the reinforcing member 250 is substantially in a shape of an elongated strip. The reinforcing member 250 includes a reinforcing portion 251. An edge portion 252 is disposed on a periphery of the reinforcing portion 251, and a first end 253 of the reinforcing member 250 abuts against a joint between the handle 201 and the main body 230 of the body 200, so as to provide support force for the joint between the handle 201 and the main body 230, and improve strength of the joint between the handle 201 and the main body 230. Preferably, the edge flap is disposed on the periphery of the reinforcing portion 251, and a thickness of the edge flap is equal to a thickness of the reinforcing portion 251.

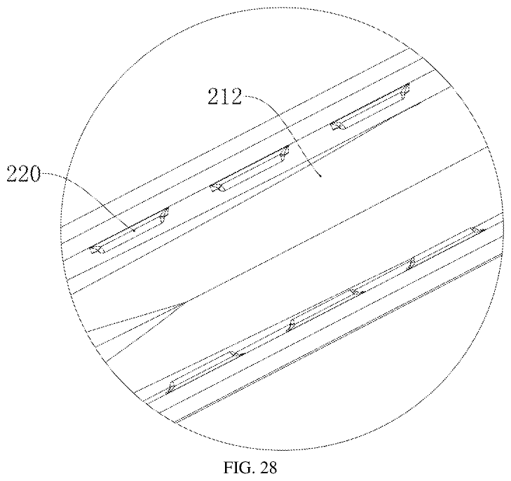

To facilitate mounting of the reinforcing member 250, a limiting member 220 is disposed on inner surfaces of both the side walls 212 and 213 of the handle 201. Referring to FIG. 28 and FIG. 29, in this embodiment, three limiting members 220 are disposed on the inner surfaces of both the side walls 212 and 213, and the plurality of limiting members 220 on the side wall 212 are arranged sequentially in the extending direction of the handle 201. Similarly, the plurality of limiting members 220 on the side wall 213 are arranged sequentially in the extending direction of the handle 201. Further, the plurality of limiting members 220 on the side wall 212 are symmetrically arranged with the plurality of limiting members 220 on the side wall 213.

Each limiting member 220 extends from the inner surfaces of the side walls 212 and 213 to the middle of the handle 201, that is, extends towards an axis direction of the handle 201. It can be seen from FIG. 29 that, the edge portion 252 of the reinforcing member 250 abuts against a side that is of the limiting member 220 and that is close to the bottom wall 211 of the handle 201, that is, the edge portion 252 is closer to the bottom wall 211 of the handle 201 than the limiting member 220. A limiting effect provided by the limiting member 220 can prevent the reinforcing member 250 from falling off from the hollow portion 202 of the handle 201.

In addition, the two edge portions 252 of the reinforcing member 250 respectively abut against the inner surfaces of the side walls 212 and 213 of the handle 201. In this way, the reinforcing member 250 can apply force to the side walls 212 and 213 of the handle 201. When a user applies force to the side walls 212 and 213 of the handle 201, the reinforcing member 250 can prevent the side walls 212 and 213 of the handle 201 from moving inwards to cause deformation of the side walls 212 and 213 of the handle 201.

A second end 254 of the reinforcing member 250 abuts against an inner surface at the end 205 of the handle 201. In this way, during use of the spork, even if the reinforcing member 250 moves in a direction close to the end 205 of the handle under force applied to the first end of the reinforcing member 250, due to force between the end 205 of the handle 201 and the second end 254 of the reinforcing member 250, the reinforcing member 250 is prevented from moving towards the end 205 of the handle 201, thereby limiting the reinforcing member 250.

In addition, an arch portion 256 is formed in the middle of the reinforcing portion 251, and the arch portion 256 is bent in a direction away from the bottom wall 211 of the handle 201. The arch portion 256 can improve strength of the reinforcing member 250, and avoid a situation that the reinforcing member 250 is easily broken under force, thereby improving strength of the handle 201.

### Sixth Embodiment

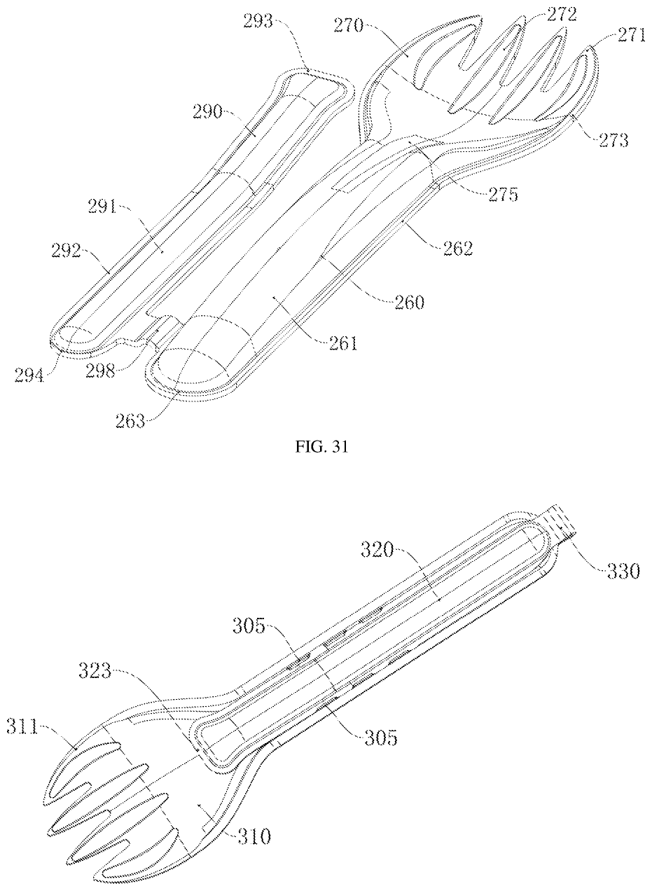

Referring to FIG. 30 and FIG. 31, the high-strength environment-friendly tableware in this embodiment is a spork made of an environment-friendly material, and the spork is provided with four teeth. The spork includes a body 260 and a reinforcing member 290, and the reinforcing member 290 may be fixedly mounted in the body 260. A structure of the body 260 of the spork is the same as that of the body of the spork in the fifth embodiment. The body 260 includes a handle 261 and a main body 270. The handle 261 is in a shape of an elongated strip, and the main body 270 is located at one end of the handle 261. A reinforcing rib 275 is disposed between the handle 261 and the main body 270. The reinforcing rib 275 is substantially in a shape of an elongated strip, and extends from the handle 261 to the main body 270. The reinforcing rib 275 is recessed from an upper surface to a lower surface of the body 260, and on a cross section in an extending direction of the reinforcing rib 275, the reinforcing rib 275 includes a concave portion and convex portions located at two ends of the concave portion.

The cross section of the reinforcing rib 275 is not recessed in one direction, but recessed and protruded in two directions, that is, the concave portion is recessed from the upper surface to the lower surface of the spork, and the two convex portions are protruded from the lower surface to the upper surface of the spork, so that the cross section of the reinforcing rib 275 is in a wave shape.

The main body 270 is provided with four teeth 271, and a concave reinforcing portion 272 is disposed in the middle of each tooth 271, and the reinforcing portion 272 is recessed from the upper surface to the lower surface of the spork. The reinforcing portions 272 can improve bending performance of the teeth 271 and prevent the teeth 271 from being fractured during use of the spork.

The handle 261 forms a recess with one end open on a cross section in an extending direction, and the recess forms a hollow portion. The cross section in the extending direction of the handle 261 includes a bottom wall and side walls located at two ends of the bottom wall. An edge flap 262 is connected to a free end of the side wall, and a thickness of the edge flap 262 is equal to a thickness of the side wall. A first edge flap 263 is also disposed at an end of the handle 261, and a thickness of the first edge flap 263 is equal to a thickness of the handle 261.

A second edge flap 273 is disposed on a periphery of the main body 270, and a second edge flap is disposed on a periphery of each tooth 271. In addition, a thickness of the second edge flap 273 is equal to a thickness of the main body 270, and corners of the second edge flap 273 are also designed as arc chamfers. Disposing the second edge flap on the periphery of the main body 270 can improve bending strength of the main body 270 and provide the main body 270 from being bent and deformed under force.

The reinforcing member 290 is mounted in the hollow portion of the handle 261, and the reinforcing member 290 is substantially in a shape of an elongated strip. The reinforcing member 290 includes a reinforcing portion 291. An edge portion 292 is disposed on a periphery of the reinforcing portion 291, and a first end 293 of the reinforcing member 290 abuts against a joint between the handle 261 and the main body 270 of the body 260, so as to provide support force for the joint between the handle 261 and the main body 270, and improve strength of the joint between the handle 261 and the main body 270. Preferably, the edge flap is disposed on the periphery of the reinforcing portion 291, and a thickness of the edge flap is equal to a thickness of the reinforcing portion 291.

To facilitate mounting of the reinforcing member 290, limiting members 281 are disposed on inner surfaces of both side walls of the handle 261. Three limiting members 281 are disposed on the inner surface of each side wall of the handle 261, and the plurality of limiting members 281 on the same side wall are arranged sequentially in the extending direction of the handle 261. In addition, the plurality of limiting members 281 on the two side walls of the handle 261 are arranged symmetrically.

Each limiting member 281 extends from the inner surfaces of the side walls of the handle 261 to the middle of the handle 261, and the edge portion 292 of the reinforcing portion 291 abuts against a lower part of the limiting member 281. A limiting effect provided by the limiting member 281 can prevent the reinforcing member 290 from falling off from the hollow portion of the handle 261.

In addition, the two edge portions 292 of the reinforcing member 290 respectively abut against the inner surfaces of the side walls of the handle 261. In this way, the reinforcing member 290 can apply force to the side walls of the handle 261. When a user applies force to the side walls of the handle 261, the reinforcing member 290 can prevent the side walls of the handle 261 from moving inwards to cause deformation of the side walls of the handle 261.

A second end 294 of the reinforcing member 290 abuts against an inner surface at the end of the handle 261. In this way, during use of the spork, even if the reinforcing member 290 moves in a direction close to the end of the handle under force applied to the first end 293 of the reinforcing member 290, due to force between the end of the handle 261 and the second end 294 of the reinforcing member 290, the reinforcing member 290 is prevented from moving towards the end of the handle 261, thereby limiting the reinforcing member 290. In addition, an arch portion is formed in the middle of the reinforcing portion 291, and the arch portion is bent in a direction away from the bottom wall of the handle 261. The arch portion can improve strength of the reinforcing member 290.

Different from the fifth embodiment, a connecting member 298 is disposed between the body 260 and the reinforcing member 290. The connecting member 298 is a flexible connecting member, a first end of the connecting member 298 is connected to the edge portion 292 of the reinforcing member 290, and a second end of the connecting member 298 is connected to one side wall of the handle 261. Preferably, the body 260 is formed integrally with the reinforcing member 290 and the connecting member 298. For example, the body 260 is molded together with the reinforcing member 290 and the connecting member 298. In this way, a thickness of the connecting member 298 is equal to a thickness of the body 260 and that of the reinforcing member 290.

It can be seen from FIG. 31 that, the connecting member 298 is located close to the end of the handle 261, and the plurality of limiting members 281 are located in the middle of the handle 261 in a length direction, so that the connecting member 298 does not affect mounting of the reinforcing member 290.

### Seventh Embodiment

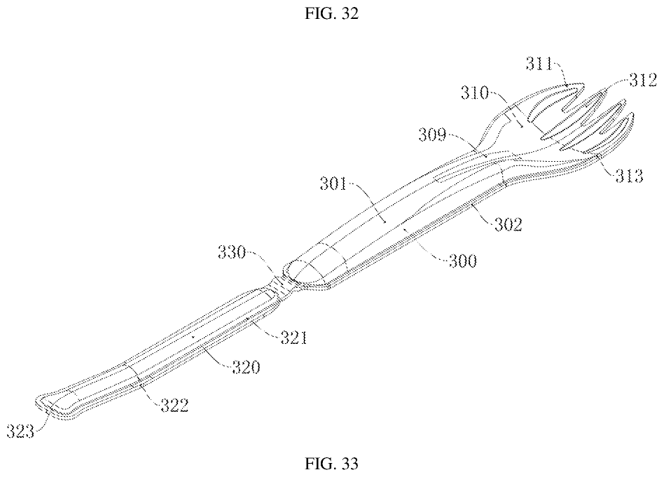

Referring to FIG. 32 and FIG. 33, the high-strength environment-friendly tableware in this embodiment is a spork made of an environment-friendly material, and the spork is provided with four teeth. The spork includes a body 300 and a reinforcing member 320, and the reinforcing member 320 may be fixedly mounted in the body 300. A structure of the body 300 of the spork is the same as that of the body of the spork in the fifth embodiment. The body 300 includes a handle 301 and a main body 310. The handle 301 is in a shape of an elongated strip, and the main body 310 is located at one end of the handle 301. A reinforcing rib 309 is disposed between the handle 301 and the main body 310. The reinforcing rib 309 is substantially in a shape of an elongated strip, and extends from the handle 301 to the main body 310. The reinforcing rib 309 is recessed from an upper surface to a lower surface direction of the body 300, and on a cross section in an extending direction of the reinforcing rib 309, the reinforcing rib 309 includes a concave portion and convex portions located at two ends of the concave portion.

The cross section of the reinforcing rib 309 is not recessed in one direction, but recessed and protruded in two directions, that is, the concave portion is recessed from the upper surface to the lower surface of the spork, and the two convex portions are protruded from the lower surface to the upper surface of the spork, so that the cross section of the reinforcing rib 309 is in a wave shape.

The main body 310 is provided with four teeth 311, and a concave reinforcing portion 312 is disposed in the middle of each tooth 311, and the reinforcing portion 312 is recessed from the upper surface to the lower surface of the spork. The reinforcing portions 312 can improve bending performance of the teeth 311 and prevent the teeth 311 from being fractured during use of the spork.

The handle 301 forms a recess with one end open on a cross section in an extending direction, and the recess forms a hollow portion. The cross section in the extending direction of the handle 301 includes a bottom wall and side walls located at two ends of the bottom wall. An edge flap 302 is connected to a free end of the side wall, and a thickness of the edge flap 302 is equal to a thickness of the side wall.

A second edge flap 313 is disposed on a periphery of the main body 310, and a second edge flap is disposed on a periphery of each tooth 311. In addition, a thickness of the second edge flap 313 is equal to a thickness of the main body 310, and corners of the second edge flap 313 are also designed as arc chamfers. Disposing the second edge flap on the periphery of the main body 310 can improve bending strength of the main body 310 and provide the main body 310 from being bent and deformed under force.

The reinforcing member 320 is mounted in the hollow portion of the handle 301, and the reinforcing member 320 is substantially in a shape of an elongated strip. The reinforcing member 320 includes a reinforcing portion 321. An edge portion 322 is disposed on a periphery of the reinforcing portion 321, and a first end 323 of the reinforcing member 320 abuts against a joint between the handle 301 and the main body 310 of the body 300, so as to provide support force for the joint between the handle 301 and the main body 310, and improve strength of the joint between the handle 301 and the main body 310. Preferably, the edge flap is disposed on the periphery of the reinforcing portion 321, and a thickness of the edge flap is equal to a thickness of the reinforcing portion 321.

To facilitate mounting of the reinforcing member 320, limiting members 305 are disposed on inner surfaces of both side walls of the handle 301. Three limiting members 305 are disposed on the inner surface of each side wall of the handle 301, and the plurality of limiting members 305 on the same side wall are arranged sequentially in the extending direction of the handle 301. In addition, the plurality of limiting members 305 on the two side walls of the handle 301 are arranged symmetrically.

Each limiting member 305 extends from the inner surfaces of the side walls of the handle 301 to the middle of the handle 301, and the edge portion 322 of the limiting member 320 abuts against a lower part of the limiting member 302. A limiting effect provided by the limiting member 302 can prevent the reinforcing member 320 from falling off from the hollow portion of the handle 301.

In addition, the two edge portions 322 of the reinforcing member 320 respectively abut against the inner surfaces of the side walls of the handle 301. In this way, the reinforcing member 320 can apply force to the side walls of the handle 301. When a user applies force to the side walls of the handle 301, the reinforcing member 320 can prevent the side walls of the handle 301 from moving inwards to cause deformation of the side walls of the handle 301. An arch portion is formed in the middle of the reinforcing portion 321, and the arch portion is bent in a direction away from the bottom wall of the handle 301. The arch portion can improve strength of the reinforcing member 320.

Different from the fifth embodiment, a connecting member 330 is disposed between the body 300 and the reinforcing member 320. The connecting member 330 is a flexible connecting member, a first end of the connecting member 330 is connected to the second end of the reinforcing member 320, and a second end of the connecting member 330 is connected to an end of the handle 301. Therefore, in this embodiment, the reinforcing member 320 is connected to a tail of the handle 301.

Preferably, the body 300 is formed integrally with the reinforcing member 320 and the connecting member 330. For example, the body 300 is molded together with the reinforcing member 320 and the connecting member 330. In this way, a thickness of the connecting member 330 is equal to a thickness of the body 300 and that of the reinforcing member 320. The connecting member 330 is disposed at the end of the handle 301, and the plurality of limiting portions 305 are located on the side walls of the handle 301, so that the connecting member 330 does not affect mounting of the reinforcing member 320.

The fifth embodiment to the seventh embodiment are described by using a spork as an example. In actual application, a table knife, a spoon, or a fork may also be provided with a reinforcing member, that is, a handle of the table knife, the spoon, or the fork is provided with a hollow portion, and limiting members are disposed on side walls of the handle. The reinforcing member may be mounted in the hollow portion of the handle and is limited by a limiting member. The reinforcing member improves strength between the handle and a main body, and improves bending strength of the two side walls of the handle.

Finally, it should be emphasized that this application is not limited to the above embodiments. For example, a shape of the reinforcing member is changed, or a quantity of the connecting member is set to two, three, or more, and these changes shall also fall within the protection scope of the claims of this application.

### INDUSTRIAL APPLICABILITY

The high-strength environment-friendly tableware in this application can be a table knife, a table fork, a spoon, a spork, or the like, which is made of environment-friendly materials and is friendly to the environment. In addition, according to this application, the reinforcing member is disposed on the handle, so as to improve strength of the joint between the handle and the main body, thereby avoiding a situation that the handle cannot be used because the joint between the handle and the main body is bent during use of the handle. In addition, the edge flaps are also disposed on the peripheries of the main body and the handle to improve strength of the handle and main body, so that the high-strength environment-friendly tableware has good bending performance and is not easily broken during use.

1. High-strength environment-friendly tableware, comprising:
a handle and a main body, wherein the main body is located at one end of the handle,
wherein
the handle has a recess, the recess forms a hollow portion, and the hollow portion extends in a length direction of the handle; and
a reinforcing member is mounted in the hollow portion, and a first end of the reinforcing member abuts against a joint between the main body and the handle.

2. The high-strength environment-friendly tableware according to claim 1, wherein
on a cross section in an extending direction of the handle, the handle has a bottom wall and side walls located at two ends of the bottom wall; and
at least one of the two side walls is provided with a limiting member, the limiting member extends on the side wall towards the middle of the handle, and an edge portion of the reinforcing member abuts against a side that is of the limiting member and that is close to the bottom wall.

3. The high-strength environment-friendly tableware according to claim 2, wherein
both side walls of the handle are provided with at least one limiting member.

4. The high-strength environment-friendly tableware according to claim 3, wherein
on the same side wall of the handle, the plurality of limiting members are arranged sequentially in the extending direction of the handle.

5. The high-strength environment-friendly tableware according to claim 2, wherein
the edge portion is disposed on both sides of the reinforcing member, and the edge portions on the two sides abut against inner surfaces of the side walls of the handle.

6. The high-strength environment-friendly tableware according to claim 2, wherein
a second end of the reinforcing member abuts against an inner surface at an end of the handle.

7. The high-strength environment-friendly tableware according to claim 2, wherein
the reinforcing member is connected to the handle by using a connecting member.

8. The high-strength environment-friendly tableware according to claim 7, wherein
the connecting member is a flexible connecting member.

9. The high-strength environment-friendly tableware according to claim 8, wherein
a first end of the connecting member is connected to the edge portion of the reinforcing member, and a second end of the connecting member is connected to the side wall of the handle.

10. The high-strength environment-friendly tableware according to claim 8, wherein
a first end of the connecting member is connected to a second end of the reinforcing member, and a second end of the connecting member is connected to an end of the handle; and
the second end of the reinforcing member is disposed opposite to the first end of the reinforcing member.

11. The high-strength environment-friendly tableware according to claim 9, wherein
the reinforcing member and the connecting member are molded together, and a thickness of the connecting member is equal to a thickness of the reinforcing member.

12. The high-strength environment-friendly tableware according to claim 2, wherein
on a cross section in an extending direction of the reinforcing member, there is an arch portion in the middle of the reinforcing member, and the arch portion is bent in a direction away from the bottom wall of the handle.

13. The high-strength environment-friendly tableware according to claim 2, wherein
a first edge flap is disposed at a free end of the side wall, a thickness of the first edge flap is equal to a thickness of the side wall, and corners of the first edge flap are arc chamfers.

14. The high-strength environment-friendly tableware according to claim 13, wherein
the first edge flaps corresponding to the two side walls are on the same plane.

15. The high-strength environment-friendly tableware according to claim 14, wherein
the side wall is disposed obliquely with the first edge flap, and an angle between the side wall and the first edge flap is an obtuse angle.

16. The high-strength environment-friendly tableware according to claim 13, wherein
a periphery of the main body is provided with a second edge flap, and a thickness of the second edge flap is equal to a thickness of the main body.

17. The high-strength environment-friendly tableware according to claim 16, wherein
the environment-friendly tableware is a fork, the main body is provided with at least two teeth, and a periphery of each tooth is provided with the second edge flap.

18. The high-strength environment-friendly tableware according to claim 17, wherein
a concave reinforcing portion is disposed in the middle of at least one of the teeth.

19. The high-strength environment-friendly tableware according to claim 13, wherein
the environment-friendly tableware is provided with a reinforcing rib, the reinforcing rib extends from the handle to the main body, and on a cross section in an extending direction of the reinforcing rib, the reinforcing rib comprises a concave portion and convex portions located at two ends of the concave portion.
